(19) United States
(12) Patent Application Publication
(10) Pub. No.: US 2010/0268606 A1
(43) Pub. Date: Oct. 21, 2010

(54) TARGETED IMAGE ADS

(75) Inventor: Alex Chih Wu, Fremont, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/424,294

(22) Filed: Apr. 15, 2009

(51) Int. Cl. G06Q 30/00

(52) U.S. Cl. 705/14.54; 705/14.51

(57) ABSTRACT

Product information specifying products or services is received, each of the products or services being associated with an advertisement. Display criteria indicating display properties associated with the product information for displaying the product information, and one or more keywords are also received. The advertisement is identified in response to the one or more keywords. Advertisement display data for displaying the advertisement on the webpage is generated. Presentation data for displaying the product information according to the display properties separate from and proximate to the webpage is generated. The advertisement display data and the presentation data are provided to a client device.

### BACKGROUND

This document relates to information presentation.

The Internet has enabled access to a wide variety of content items, e.g., video and/or audio files, webpages for particular subjects, news articles, etc. For example, content items of particular interest to a user can be identified by a search engine in response to a user query. The query can include one or more search terms, and the search engine can identify and, optionally, rank the content items based on the search terms in the query and present the content items to the user (e.g., according to the rank).

Such access to these content items has likewise enabled opportunities for targeted advertising. In some online advertising systems, advertisements are also identified in addition to content items and displayed for the user. Often, users cannot readily determine whether the advertisements that are identified are associated with products they may be interested in purchasing. For example, advertisements associated with the query often only include text describing products or services, but may not include any specific information associated with each of the products. For example, an advertisement related to the query “tires” may include a creative that describes a tire store as having a wide variety of tire brands in stock; the creative, however, does not describe or give examples of the various tire brands. In order to determine whether the products of an advertisement are relevant, the user often needs to request a landing page associated with the advertisement. This often requires that a web browser “move away” from the webpage including the advertisement to render the landing page of the advertisement. Going to and from a search results page to various landing pages can degrade the user experience.

### SUMMARY

In general, one aspect of the subject matter described in this specification can be implemented in methods that include the actions receiving product information specifying products or services, each of the products being associated with an advertisement; receiving display criteria indicating display properties associated with the product information for displaying the product information; receiving one or more keywords; identifying the advertisement in response to the one or more keywords; generating advertisement display data for displaying the advertisement on the web page; generating presentation data for displaying the product information according to the display properties separate from and proximate to the web page; and providing the advertisement display data and the presentation data to a client device.

These and other implementations can optionally include one or more of the following features. The advertisement display data is operable to cause the client device to display a product element proximate to the advertisement and to display a window including the product information in response to a selection of the product element. The product information includes at least one of an image, a description, a number of clicks, a price, a brand identification, and a categorization. One of the products can be a promotional product and the product information includes at least one of a start date, an end date, and a discount associated with the promotional product, and wherein the promotional product is displayed only if the start date occurs after a current date and the current date is before the end date.

Particular embodiments of the subject matter described in this specification can be implemented so as to realize one or more of the following advantages. Product information associated with advertisements provided with search results can be displayed in an overlay window without altering the search results or other content on the web page on which the search results are displayed. Product information associated with advertisements can be displayed in an overlay window environment separate from the web page on which the search results are displayed. An advertiser associated with the advertisements can define the product information as well as the order and other display properties associated with the product information.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online environment.

FIGS. 2A and 2B are illustrations of example webpages rendered with product information displayed in overlay windows.

FIG. 3 is a flow chart of an example process for providing advertisement display and presentation data to a client.

FIG. 4 is block diagram of an example computer system that can be used to facilitate generation of advertisement display and presentation data.

Like reference numbers and designations in the various drawings indicate like elements.

### DETAILED DESCRIPTION

### §1.0 Advertisement Publishing and Tracking

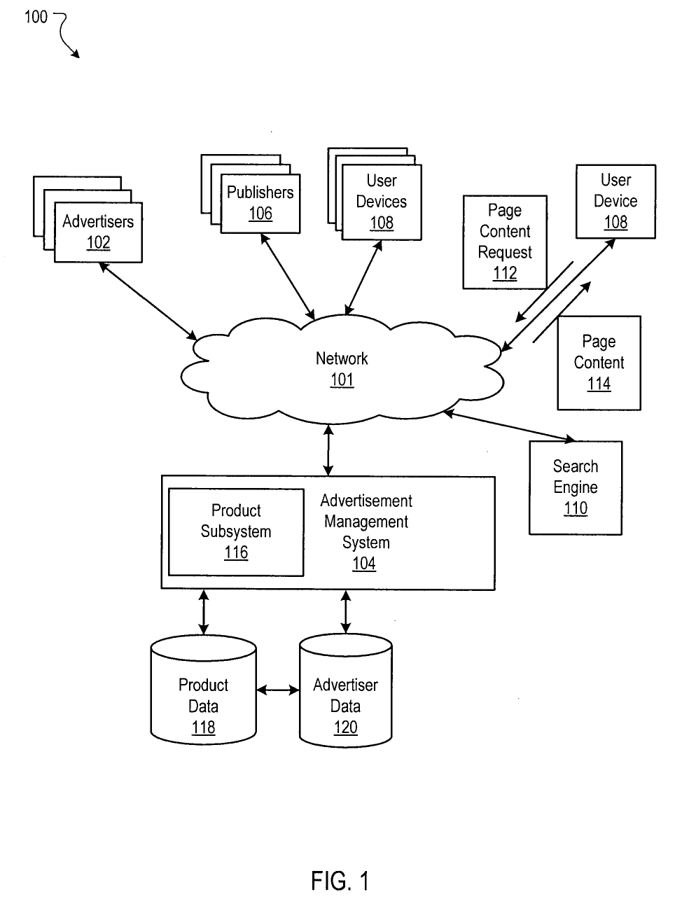

FIG. 1 is a block diagram of an example online environment 100. The online environment 100 can facilitate the identification and serving of content items, e.g., webpages, advertisements, etc., to users. A computer network 101, such as a local area network (LAN), wide area network (WAN), the Internet, or a combination thereof, connects content sponsors (e.g., advertisers 102), an advertisement management system 104, publishers 106, user devices 108, and a search engine 110. The online environment 100 may include many thousands of advertisers 102, publishers 106 and user devices 108. While reference is made below to advertisement, other forms of content including other forms of sponsored content can be provided in the online environment 100.

In some implementations, one or more advertisers 102 can directly, or indirectly, enter, maintain, and track advertisement information in the advertising management system 104. The advertisement information can include advertisements that the advertiser 102 has provided for presentation on publisher webpages and on search result webpages. The advertisements can be in the form of graphical advertisements, such as banner advertisements, text only advertisements, image advertisements, video advertisements, advertisements combining one of more of any of such components, etc., or any other type of electronic advertisement document. The advertisements may also include embedded information, such as links, meta-information, and/or machine executable instructions, such as HTML or JavaScript™. The advertisement information and corresponding advertisements can be stored in an advertiser data store 120 that is coupled to the advertisement management system 104.

A user device 108 can submit a page content request 112 to a publisher 106 or the search engine 110. In some implementations, page content 114 can be provided to the user device 108 in response to the request 112. The page content 114 can include sponsored content (e.g., advertisements) provided by the advertisement management system 104, or can include executable instructions, e.g., JavaScript™, that can be executed at the user device 108 to request sponsored content advertisements from the advertisement management system 104. Example user devices 108 include personal computers, mobile communication devices, television set-top boxes, etc.

Requests for sponsored content (e.g., advertisements) can be received from the publishers 106. For example, one or more publishers 106 can submit advertisement requests for one or more advertisements to the advertisement management system 104. The advertisement management system 104 responds by sending the advertisements to the requesting publisher 106 for placement on a publisher's webpage. The advertisements can include embedded links to landing pages (e.g., pages on the advertisers' 102 websites) that a user device 108 is directed to when a user selects an advertisement that is presented on the publisher's web property. The requests for advertisements can also include content request information. This content request information can include the content itself (e.g., page or other content document), a category corresponding to the content or the content request (e.g., arts, business, computers, arts-movies, arts-music, etc.), part or all of the content request, content page, content type (e.g., text, graphics, video, audio, mixed media, etc.), geo-location information, etc.

In some implementations, a publisher 106 can combine the requested content with one or more of the advertisements provided by the advertisement management system 104. This combined requested content and advertisements can be sent to the user device 108 that requested the content as page content 114 for presentation in a viewer (e.g., a browser or other content display system). The publisher 106 can transmit information about the advertisements back to the advertisement management system 104, including information describing how, when, and/or where the advertisements are to be rendered (e.g., in HTML or JavaScript™).

Publishers 106 can include general content servers that receive requests for content (e.g., articles, discussion threads, music, video, graphics, search results, webpage listings, information feeds, etc.), and retrieve the requested content in response to the request. For example, content servers related news content providers, retailers, independent blogs, social network sites, or any other entity that provides content over the network 101 can be a publisher 106.

Sponsored content (e.g., advertisements) can also be provided using the search engine 110. The search engine 110 can receive search queries and in response accesses an index of documents (e.g., from an index of webpages) and generate search results that identify documents that are responsive to the query. Each search result can include, for example, a webpage title, a snippet of text extracted from the webpage, and a hypertext link to those webpage. The search results may be grouped into a predetermined number of (e.g., ten) search results.

The search engine 110 can submit a request for advertisements to the advertisement management system 104. The request may include a number of advertisements desired and may also include the query, information based on the query (such as geo-location information, whether the query came from an affiliate and an identifier of such an affiliate), and/or information associated with, or based on, the search results. The search engine can combine the search results with one or more of the advertisements provided by the advertisement management system 104. This combined information can then be forwarded to the user that requested the content in the form of a search results page.

The advertisers 102, publishers 106, user devices 108, and/or the search engine 110 can also provide usage information to the advertisement management system 104. This usage information can include measured or observed user behavior related to advertisements that have been served, such as, for example, whether or not a conversion or a selection related to an advertisement has occurred. The advertisement management system 104 performs financial transactions, such as crediting the publishers 106 and charging the advertisers 102 based on the usage information. Such usage information can also be processed to measure performance metrics, such as an impression count, a click-through-rate (“CTR”), conversion rate, etc.

An impression can occur when an advertisement is presented to a user. An impression count can track the number of times that an advertisement has been presented to a user. For example, when a user device 108 requests a webpage, multiple advertisements can be provided to the user device 108 with the webpage. Each of the advertisements that are provided with the webpage can have an impression counter incremented because an advertisement impression has occurred. The total number of times that the advertisement has been provided to a user device can be tracked with the impression counter and stored as the impression count.

A click-through occurs when a user of a user device 108, selects or “clicks” on a link to a content item returned by the publisher 106 or the advertising management system 104. The CTR is a performance metric that is obtained by dividing the number of users that clicked on the content item, e.g., a link to a landing page, an advertisement, or a search result, by the number of times the content item was delivered to user devices 108.

A conversion occurs when a user consummates a transaction related to a previously served advertisement. What constitutes a conversion may vary from case to case and can be determined in a variety of ways. For example, a conversion may occur when a user clicks on an advertisement, is referred to the advertiser's webpage, and consummates a purchase there before leaving that webpage. Other actions that constitute a conversion can also be used.

### §2.0 Product Information Display

The advertisement management system 104 receives advertisement information including product information that specifies various products or services (hereinafter referred to in the collective as merely “products”) from advertisers. The advertisement management system 104 can store the advertisement and product information in a product data store 118. An advertiser 102 can provide the advertisement management system 104 data that can be used to identify target webpages on which the advertiser 102 can place advertisements. For example, an advertiser 102 can access the advertisement management system 104 and enter keywords that can be used to target advertisements to a webpage.

In some implementations, the advertisement management system 104 serves advertisements that include a product information display capability. For example, the advertisements may each be associated with one or more related products and when the advertisements are provided. In some implementations, the product information can be selected by advertisers and can include information about associated products that the advertisers currently sells/services/supports.

To facilitate the display of such product information, the advertisement management system 104 includes a product subsystem 116. The product subsystem 116 receives display criteria indicating display properties associated with the product information for displaying the product information, and generates advertisement display data and, in some implementations, presentation data. The advertisement display data is for displaying the advertisement on the webpage, and the presentation data is for displaying the product information in an overlay window according to the display properties. In some implementations, the overlay window is displayed separate from and proximate to the webpage. As used herein, the term “proximate to the webpage” means next to the webpage window, partially overlapping the web page window so that part of the overlay window is displayed on top of the webpage window, or entirely overlapping the web page window so that all of the overlay window is displayed on top of the webpage window.

In some implementations, the advertisement display data is operable to cause the user device to display a selectable product element proximate to the advertisement. The product information associated with an advertisement may thus be selectively displayed on the user device 108 when the associated selectable product element is selected by a user.

In some implementations the advertisement display causes the user device, in response to a selection of the product element, to display the product information associated with the advertisement according to the presentation data in an overlay window proximate to the advertisement. In this way, the user may view a particular advertisement (e.g., an advertisement in the form of a creative for an online florist) and decide whether or not to display associated product information, such as specific floral arrangements that the user can order from the advertiser associated with the advertisement.

The product information can be displayed according to display criteria that indicate display properties associated with the product information. The product information and the display criteria can be defined by an advertiser associated with the advertisement. The overlay window displaying the product information can be displayed proximate to the webpage in response to the selection of the product element. The order of the products displayed and the length of time that each product is displayed can be defined by the advertiser.

In some implementations, the display properties can define an order that the product information is displayed when more than one product is provided by the advertiser 102. For example, if product information for four products are provided by the advertiser 102, the advertiser can also provide display properties that define the order in which product information for the four products will be displayed when they are presented on the client device.

The display properties can also define an amount of time each product is displayed. For example, the display properties can define a number of seconds or minutes to display product information for each product when more than one product is provided by the advertiser 102.

The display properties can also define a time period that each product is displayed. For example, the display properties may define that product information for a product be displayed for a certain number of days or a certain month during the year.

In some implementations, the product information provided by the advertiser 102 can be related to a promotional product. A promotional product is a product that is only available by the advertiser 102 for a predetermined amount of time, or is associated with a special offer, such as a price discount or free additional service or feature, for a predetermined amount of time or for a limited quantity of the products. The promotion for the promotional product includes a start date that the promotion will be made available, an end date that the promotion will end. When the promotional product information is provided by the advertiser 102, the product subsystem 116 determines whether the start date is after a current date and the end date is before the current date before providing the promotional product information for display in the overlay window.

Upon selection of the product element, the product information is displayed (e.g., in an overlay window). In some implementations, display of the overlay window does not disrupt the content of the webpage on which the search results and advertisement associated with the products in the overlay window are displayed, i.e., the overlay window does not change the display of the advertisements or the search results displayed on the webpage. For example, the overlay window can be displayed proximate to a search results webpage displaying search results and advertisements, or proximate to a publisher webpage display publisher content and one or more related advertisements.

In some implementations, the overlay window is displayed proximate to the webpage in the same location relative to the webpage. Therefore, the advertisement associated with the overlay window does not affect where the window is displayed. In other implementations, the overlay window is displayed proximate to the webpage and relative to the advertisement associated with the currently selected window element.

In some implementations, the presentation data also provides functionality for a user to be able to scroll through products provided by an advertiser 102 if more than one product is provided. For example, the presentation data can provide for scroll buttons to be displayed with the product information in the overlay window that allow a user to scroll from one product to a next product or previous product in the overlay window.

Product information can be provided for each specific product the advertiser desires to promote. In some implementations, the advertiser 102 can associate each particular set of product information with keywords and can optionally specify a relevance strength with the keywords. The advertisement management system 104 can maintain click through rate of each set of product information, and can select the most relevant set of product information based on the keyword relevance of the search query and/or based on the click through rate of the particular product information for a product, or the combination of both.

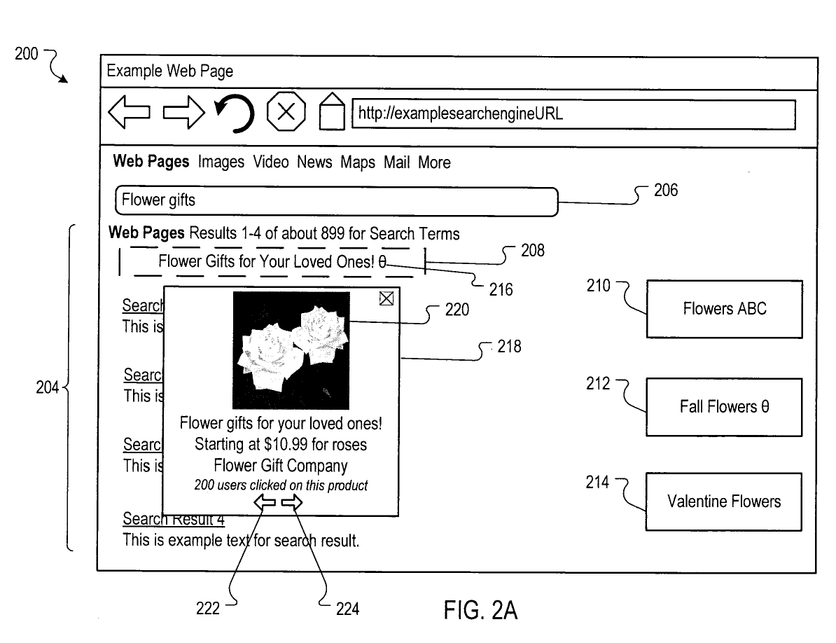

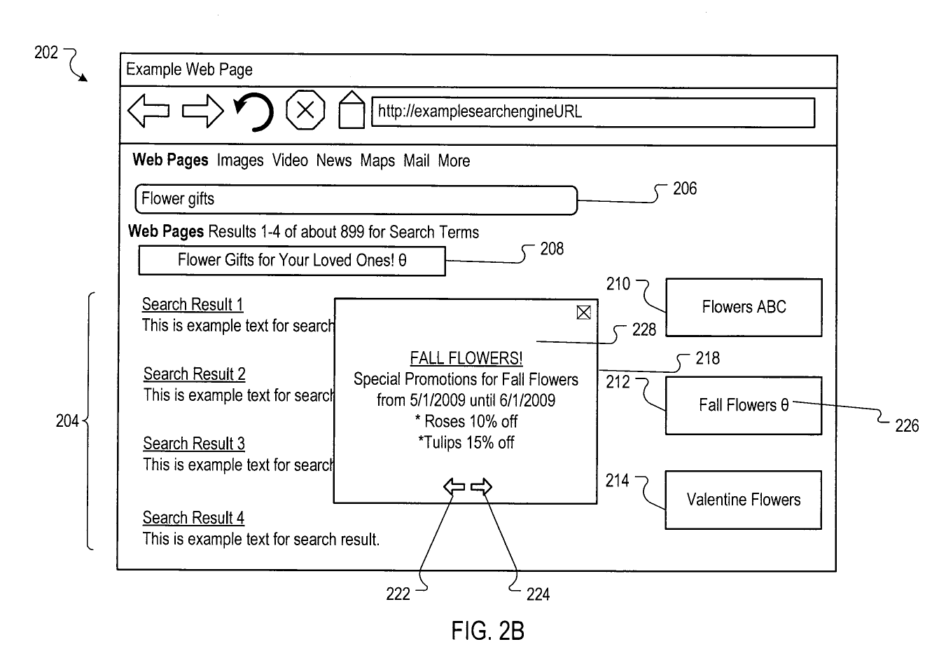

FIGS. 2A and 2B are example screenshots 200 and 202 that include overlay windows used to display product information corresponding to advertisements. For example, the screenshot 200 may be displayed in a user's browser on a user device 108, such as a smart phone, a personal computer, a personal digital assistant (PDA), or some other wired or wireless electronic device. The screenshot 200 includes a search results area 204 that can display search results. For example, the search results displayed in the search results area 204 may be in response to a specific search query, such as a “flower gifts” search term 206 that the user may enter in a browser to locate online florists that sell flowers as gifts. In response to the search term 206, the system can display advertisements responsive to the query. For example, the system can display advertisements 208, 210, 212, and 214 in response to the “flower gifts” search term 206.

Advertisements 208, 210, 212, and 214 are displayed in the search results area 204. The advertisement 208 includes a product element 216. If the user is interested in viewing products corresponding to the advertisement 208, the user may select the product element 216 to display the corresponding product information provided by the advertiser associated with the advertisement 208.

Selection of the product element 216 causes the user device to display an overlay window 218 proximate to the webpage displaying the search results 204 and advertisements 208, 210, 212, and 214. Each of the products included in the overlay window 218 may include product information 220 such as an image of the product, a description of the product, a price associated with the product, a brand associated with the product, a categorization associated with the product and a number of clicks associated with the product. The number of clicks can indicate the number of times the product in the overlay window 218 has been selected by other users.

Other information or controls that the user may employ to obtain additional product information or buy the product can also be included. In some implementations, buying a product may be accomplished by adding the product to an online shopping cart for later checkout and payment. Additional controls may exist for controlling the visual presentation of the product, or to control any audio component of the product's presentation, or other such features.

In some implementations, other user interfaces or other elements may be used in addition to (or as an alternative to) the product element 216. For example, the user may simply mouse over the advertisement 208 (i.e., cause a cursor to hover over the advertisement 208) for a predetermined period of time to display the overlay window 218. For example, if a user hovers over the advertisement 208 for three seconds, the overlay window 218 can appear.

The number of products that are included with an advertisement in the overlay window 218 may be selected by the advertiser associated with the advertisement for which the products are displayed. For example, the advertiser for advertisement 208 may have selected three products to be displayed in the overlay window 218. In some implementations, the overlay window 218 that displays the products may include scroll buttons 222 and 224 or other control for displaying the product information for one product at a time, and the scroll buttons 222 and 224 can be used to scroll from product information for different products.

In some implementations, the products returned for an advertisement may be ranked according to an order defined by the advertiser. For example, the advertiser may select the order the products are displayed in the overlay window 218.

In some implementations, the order can be based on a click-through rate associated with each product. The products can be ordered based on decreasing or increasing order of click-through rate. For example, as described above, advertisement 208 can be associated with three products. Each product is associated with a click-through rate. The three products can be displayed in the overlay window 218 with the product with the highest click-through rate displayed first and the other products can be displayed after the first product in decreasing order of click-through rate. Alternatively, the product with the lowest click-through rate can be displayed first and the other products can be displayed after the first product in increasing order of click-through rate.

In some implementations, if more than one product is associated with an advertisement, each product can be displayed in the overlay window 218 for a predefined period of time. In some implementations, the advertiser can define the period of time each product is displayed. For example, the advertiser can define each product to be displayed for two seconds. In other implementations, each product can be displayed until the user indicates that the next product should be shown. For example, the user can select the scroll buttons 222 and 224 to be taken to product information for the next or previous product.

In some implementations, a user can click on the product in the overlay window 218 and be directed to a landing page associated with the product. The landing page is the advertiser's webpage associated with the product clicked on in the overlay window 218. The user can be shown the exact product or similar product as was displayed in the overlay window 218. Conversely, selecting the advertisement 208 may cause the user to be directed to the home page of the advertiser instead of a particular product.

In some implementations, the user can minimize the overlay window 218 to go back to browsing the webpage shown in screenshot 202. In some implementations, if the user clicks on another product element associated with a different advertisement, the overlay window 218 can automatically maximize and display the products associated with the selected product element. In other implementations, a new overlay window can be displayed upon selection of the new product element. Therefore, it is possible for more than one overlay window to be displayed to the user.

In other implementations, the overlay window 218 may close when the user selects any element of the webpage shown in the screenshot 202.

In some implementations, the advertisement that is associated with the current overlay window can be highlighted to indicate to the user the advertisement that is associated with the current overlay window. For example, the advertisement 208 can change from a white color to a gray color, as indicated by the dashed outline, upon selection of the product element 216 and while the overlay window 218 is displayed. In some implementations, the advertisement can remain highlighted while the overlay window 218 is displayed, even if the overlay window 218 is minimized. In other implementations, minimizing the overlay window 218 or closing the overlay window 218 can cause the highlighted advertisement to be displayed in the original form without highlighting. In this way, the user can easily determine which advertisement display element was selected. In still other implementations, once a display element is selected the advertisement remains highlighted for the remaining time the user is browsing the webpage with the search results and advertisements.

FIG. 2B is a screenshot 202 of the search results area 204 with an overlay window 218 that is displayed upon selection of the product element 226. In the example screenshot 202, the promotional product information 228 is displayed in the overlay window 218 for a promotional product.

The promotional product information 228 is associated with the advertisement 212. Upon selection of the product element 226, the overlay window 218 is displayed and the promotional product information 228 is displayed in the overlay window 218. The promotional product information 228 includes a start date “May 1, 2009” and an end date “Jun. 1, 2009”, indicating the promotional products can only be purchased between these dates. The promotional product information 228 also includes discounts of 10% off roses and 15% off tulips. The promotional product information 228 is provided to the client device for display in the browser shown in the screenshot 202 as is determined that the start date “May 1, 2009” is before the current date and the end date “Jun. 1, 2009” is after the current date.

In some implementations, once the user selects a product element associated with a new advertisement, for example, the product element 226, and new products are displayed in the overlay window 218, the user can use the scroll buttons 222 and 224 to navigate to product information associated with previous advertisements. For example, if the user selected the product element 226 and the flower product information 220 is displayed in the overlay window 218, upon selection of the product element 226, the promotional product information 228 can be displayed in the same overlay window 218. The user can, however, use the scroll button 222 to go to the previous flower product 220 associated with the product element 216. In some implementations, selection of product information for a corresponding advertisement causes the corresponding advertisement to be highlighted or presented in some other visually distinct manner. This optional feature facilitates comparison of products from different advertisers in the same overlay window 218.

### §3.0 Example Process Flows

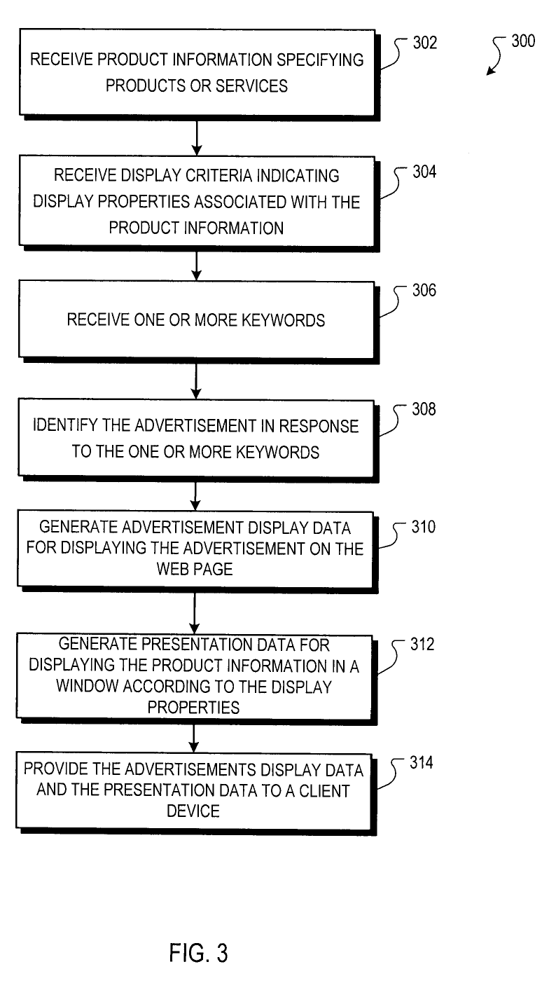

FIG. 3A is a flow chart of an example process 300 for providing advertisement display and presentation data to a client device. The process 300 can be implemented, for example, by the product subsystem 116 and/or the advertisement management system 104 of FIG. 1.

Product information specifying products or services is received (302). Each of the products or services can be associated with an advertisement. In some implementations, the product information can be received from the advertiser associated with each advertisement. In some implementations, the product information includes at least one of an image, a description, a number of clicks, a price, a brand identification, or a categorization. The product information can be received, for example, by the product subsystem 116.

Display criteria indicating display properties associated with the product information can be received (304). In some implementations, the display properties can define an order that the product information is displayed for each of the products, and an amount of time the product information is displayed for each of the products or services. The display criteria can be received, for example, by the product subsystem 116.

One or more keywords can be received (306). In some implementations, the one or more keywords can be received from a query submitted by a user on a search engine webpage. In other implementations, the keywords can be received from a publisher 106. The one or more keywords can be received, for example, by the product subsystem 116.

Advertisements can be identified in response to the one or more keywords (308). The advertisement can be identified, for example, by the advertisement management system 104.

Advertisement display data is generated for displaying the product information (e.g., in a window) according to the display properties (310). In some implementations, the window is separate from and proximate to the webpage. The advertisement display data can be operable to cause the client device to display a product element proximate to the advertisement and to display the window in response to a selection of the product element. The advertisement display data can be generated, for example, by the product subsystem 116.

In some implementations, the product information may not necessarily be associated with the keywords used in locating the advertisements; i.e., the advertiser 102 may specify a static set of product information for a set of products that is always shown in the overlay window. In other implementations, the provided product information may be associated with keywords used for locating advertisements, and may be selected based on the presence of keywords in the search query and one or more other metrics, such as a click through rate of the product information in the overlay window. Other targeting information can also be used, such as customer or user profile information, etc.

Presentation data is generated for displaying the product information (e.g., in a window) according to the display properties (312). The presentation data can be generated, for example, by the product subsystem 116.

The advertisement display data and the presentation data is provided to a client (312). The advertisement display data and the presentation data can, for example, be provided by the product subsystem 116.

### §4.0 Example Computer System

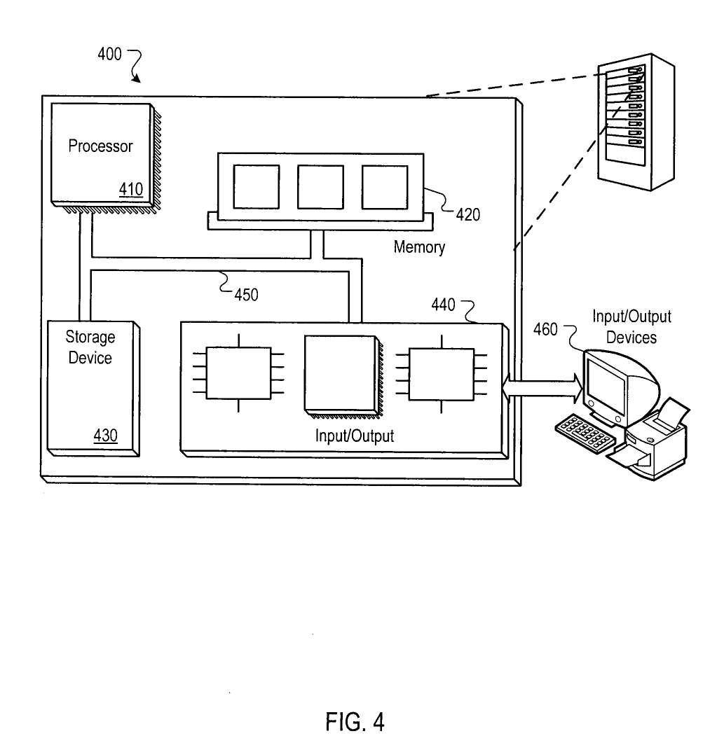

FIG. 4 is block diagram of an example computer system 400 that can be used to facilitate generation of advertisement display and presentation data. For example, the product subsystem 116 and/or advertisement management system 104 can be implemented using one or more of the computer systems 400.

The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In some implementations, the memory 420 is a computer-readable medium. In other implementations, the memory 420 is a volatile memory unit. In still other implementations, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, or some other large capacity storage device.

The input/output device 440 provides input/output operations for the system 400. In some implementations, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, a processing system. The computer readable medium can be a machine readable storage device, a machine readable storage substrate, a memory device, a composition of matter effecting a machine readable propagated signal, or a combination of one or more of them.

The term “processing system,” “processing devices” and “processing subsystem” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, data processing apparatus.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. While reference is made to delivering advertisements, other forms of content including other forms of sponsored content can be delivered.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
receiving product information specifying products or services, each of the products or services being associated with an advertisement;
receiving display criteria indicating display properties associated with the product information for displaying the product information;
receiving one or more keywords;
identifying the advertisement in response to the one or more keywords;
generating advertisement display data for displaying the advertisement on a webpage;
generating presentation data for displaying the product information according to the display properties separate from and proximate to the webpage; and
providing the advertisement display data and the presentation data to a client device.

2. The method of claim 1, wherein the advertisement display data is operable to cause the client device to display a product element proximate to the advertisement and to display a window including the product information in response to a selection of the product element.

3. The method of claim 1, wherein one of the products is a promotional product and the product information includes at least one of a start date, an end date, and a discount associated with the promotional product, and wherein the promotional product is displayed only if the start date occurs after a current date and the current date is before the end date.

4. The method of claim 1, wherein the product information includes at least one of an image, a description, a number of clicks, a price, a brand identification, or a categorization.

5. The method of claim 1, wherein the display properties define an order that the product information is displayed for each of the products, and an amount of time the product information is displayed for each of the products.

6. The method of claim 1, wherein the order is based on a click-through rate.

7. The method of claim 2, wherein the advertisement on the webpage does not change in response to a selection of the product element.

8. The method of claim 1, wherein the window includes a navigational element used to scroll through the product information for each product.

9. A system comprising:
one or more computers; and
a computer-readable medium coupled to the one or more computers having instructions stored thereon which, when executed by the one or more computers, cause the one or more computers to perform operations comprising:
receiving product information specifying products or services, each of the products or services being associated with an advertisement;
receiving display criteria indicating display properties associated with the product information for displaying the product information;
receiving one or more keywords;
identifying the advertisement in response to the one or more keywords;
generating advertisement display data for displaying the advertisement on a webpage;
generating presentation data for displaying the product information according to the display properties separate from and proximate to the webpage; and
providing the advertisement display data and the presentation data to a client device.

10. The system of claim 9, wherein the advertisement display data is operable to cause the client device to display a product element proximate to the advertisement and to display a window including the product information in response to a selection of the product element.

11. The system of claim 9, wherein one of the products is a promotional product and the product information includes at least one of a start date, an end date, and a discount associated with the promotional product, and wherein the promotional product is displayed only if the start date occurs after a current date and the current date is before the end date.

12. The system of claim 9, wherein the product information includes at least one of an image, a description, a number of clicks, a price, a brand identification, or a categorization.

13. The system of claim 9, wherein the display properties define an order that the product information is displayed for each of the products, and an amount of time the product information is displayed for each of the products.

14. The system of claim 13, wherein the order is based on a click-through rate.

15. The system of claim 10, wherein the advertisement on the webpage does not change in response to a selection of the product element.

16. The system of claim 9, wherein the window includes a navigational element used to scroll through the product information for each product.

17. A computer storage medium encoded with a computer program, the program comprising instructions that when executed by data processing apparatus cause the data processing apparatus to perform operations comprising:
receiving product information specifying products or services, each of the products or services being associated with an advertisement;
receiving display criteria indicating display properties associated with the product information for displaying the product information;
receiving one or more keywords;
identifying the advertisement in response to the one or more keywords;
generating advertisement display data for displaying the advertisement on a webpage;
generating presentation data for displaying the product information according to the display properties separate from and proximate to the webpage; and
providing the advertisement display data and the presentation data to a client device.

18. The computer storage medium of claim 17, wherein the advertisement display data is operable to cause the client device to display a product element proximate to the advertisement and to display a window including the product information in response to a selection of the product element.

19. The computer storage medium of claim 17, wherein one of the products is a promotional product and the product information includes at least one of a start date, an end date, and a discount associated with the promotional product, and wherein the promotional product is displayed only if the start date occurs after a current date and the current date is before the end date.

20. The computer storage medium of claim 17, wherein the product information includes at least one of an image, a description, a number of clicks, a price, a brand identification, or a categorization.
